(19) United States
(12) Patent Application Publication
(10) Pub. No.: US 2008/0142607 A1
(43) Pub. Date: Jun. 19, 2008

(54) AIR CONDITIONING SYSTEM AND METHOD OF CONTROLLING THE SAME

(75) Inventors: Katsuji Yoshii, Tokyo (JP); Shigeo Yatsu, Gunma (JP)

Correspondence Address: DARBY & DARBY P.C., P.O. BOX 770, Church Street Station, New York, NY, 10008-0770, US

(73) Assignee: SANYO Electric Co., Ltd., Osaka (JP)

(21) Appl. No.: 11/957,664

(22) Filed: Dec. 17, 2007

(30) Foreign Application Priority Data
Dec. 19, 2006 (JP) 2006-341242

(51) Int. Cl. G05B 15/00; G05D 99/00

(52) U.S. Cl. 236/51; 700/277

(57) ABSTRACT

In an air conditioning system containing at least one outdoor unit and plural indoor units and a central control device for concentrically controlling the overall air conditioning system and calculating an energy using charge corresponding to an energy using amount of each indoor unit as a charge proration data, the central control device includes an operation data obtaining unit for obtaining operation data based on an operation state of each indoor unit every predetermined time, a storing unit for successively storing the obtained operation data in a database, and a calculation unit for extracting the operation data used to calculate the charge proration data from the database and calculating the charge proration data on the basis of the extracted operation data.

The present application claims priority under 35 U.S.C. §119 to Japanese Patent Application No. 2006-341242 filed on Dec. 19, 2006. The contents of the application are incorporated herein by reference in its entirety.

### BACKGROUND OF THE INVENTION

1. Field of the Invention

The present invention relates to an air conditioning system in which air conditioners each having an outdoor unit and plural indoor units are concentrically controlled by a central control device and the central control device calculates an energy proportional distribution rate (hereinafter referred to as “proration rate”) of each indoor unit, and a method of controlling the same.

2. Description of the Related Art

In an air conditioning system provided in a building or the like, one or plural air conditioners each of which has an outdoor unit and plural indoor units are concentrically controlled by a single central control device. In some cases, such an air conditioning system is set under such an environment that plural users coexist. In such an environment, in order to calculate a power consumption charge in accordance with consumed power amount of each user, a central control device calculates an air-conditioning proration rate every indoor unit on the basis of an integrated operation time of each indoor unit, and multiplies the consumed power amount of the air conditioning system by the air-conditioning proportional distribution rate (proration rate), whereby the consumed power amount and the power consumption charge can be calculated every indoor unit (for example, see JP-A-5-157336). When the power consumption charge of each user is calculated, it is necessary to calculate the power consumption charge for the consumed power of each indoor unit neither too much nor too little and present the power consumption charge to each user. Accordingly, a calculation method which is as accurate and fair as possible is required as the method of calculating the air-conditioning proration rate.

In some cases, the central control device in the air conditioning system as described above obtains operation data generated on the basis of the operation condition of each indoor unit every 15 minutes, for example, and when obtaining operation data corresponding to one day of each indoor unit, the central control device executes day-by-day processing of calculating the charge prorating data on the basis of the obtained operation data of one day.

Since this day-by-day processing occupies the calculation processing performance of the central control device, it has been difficult to obtain new operation data from the indoor unit during the day-by-day processing. Furthermore, there is a case where operation data must be deleted to save the storage capacity of the central control device when the day-by-day processing is executed. In the construction as described above, once the day-by-day processing fails, the data to be subjected to the day-by-day processing at that day may be missing because the original operation data of the day concerned has been already deleted. Furthermore, once the operation data are subjected to the day-by-day processing, the original operation data are deleted, and thus it is impossible to re-calculate charge prorating data on the basis of the original operation data before the day-by-day processing.

### SUMMARY OF THE INVENTION

The present invention has been implemented in view of the foregoing situation, and has an object to provide an air conditioning system that can surely obtain operation data, and in which data used to calculate charge prorating data are prevented from being missing, and further even when charge prorating data is once calculated, the charge prorating data can be re-calculated, and a method of controlling the air conditioning system.

In order to attain the above object, there is provided an air conditioning system containing at least one outdoor unit and plural indoor units and a central control device for concentrically controlling the overall air conditioning system and calculating an energy using charge corresponding to an energy using amount of each indoor unit as a charge proration data, wherein the central control device comprises an operation data obtaining unit for obtaining operation data based on an operation state of each indoor unit every predetermined time, a storing unit for successively storing the obtained operation data in a database, and a calculation unit for extracting the operation data used to calculate the charge proration data from the database and calculating the charge proration data on the basis of the extracted operation data.

In the above air conditioning system, the database is created in a unique file format usable by the central control device, and the central control device creates history data in a general-purpose file format usable by external equipment on the basis of the operation data stored in the database.

In the above air conditioning system, the history data are grouped on a monthly basis, daily-basis history data of past one day are successively added to the history data of a present month every time one day elapses, and all daily-basis history data stored in the history data of the present month can be referred to when the history data of the present month are referred to on some day of the present month.

In the above air conditioning system, the central control device has a hard disk for backing up the operation data stored in the data base.

A method of controlling an air conditioning system containing at least one outdoor unit and plural indoor units and controlling the overall air conditioning system and calculating an energy using charge corresponding to an energy using amount of each indoor unit as a charge proration data, comprises: an operation data obtaining step for obtaining operation data based on an operation state of each indoor unit every predetermined time; a storing step for successively storing the obtained operation data in a database; and a calculation step for extracting the operation data used to calculate the charge proration data from the database and calculating the charge proration data on the basis of the extracted operation data.

According to the present invention, the operation data of each indoor unit are successively stored into the data base every time the operation data are obtained, and when the charge proration data is calculated, the operation data are extracted from the data base to calculate the charge proration data. Therefore, the daily processing is not executed, the operation data can be surely obtained, and the data used to calculate the charge proration data can be prevented from being missing, and further even when the charge proration data are once calculated, the charge proration data can be re-calculated.

### BRIEF DESCRIPTION OF THE DRAWINGS

FIG. 1 is a systematic diagram showing an air conditioning system according to an embodiment;

FIG. 2 is a flowchart showing data obtaining processing and output processing by a communication adaptor; and

FIG. 3 is a flowchart showing the data obtaining processing by a central control device.

### DETAILED DESCRIPTION OF THE PREFERRED EMBODIMENTS

Preferred embodiments according to the present invention will be described.

### [1] First Embodiment

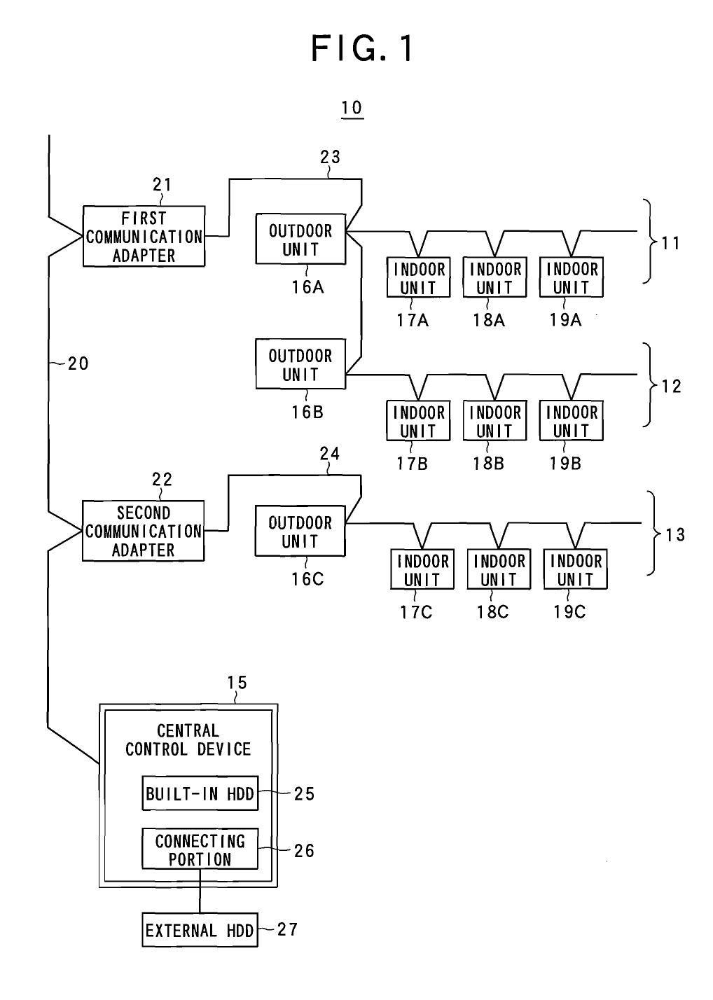

FIG. 1 is a systematic diagram showing an air conditioning system according to an embodiment.

In an air conditioning system 10, a first air conditioner 11 constituting a first refrigerant system and a second air conditioner 12 constituting a second refrigerant system are connected through a first communication adaptor 21 to a central control device 15 for concentrically managing/controlling the air conditioners. Furthermore, a third air conditioner 13 constituting a third refrigerant system is connected to a central control device 15 through a second communication adaptor 22. Accordingly, in the air conditioning system 10, the respective air conditioners 11, 12 and 13 are concentrically controlled by the central control device 15.

The first air conditioner 11 is a multi-type air conditioner in which three indoor units 17A, 18A and 19A are connected to an outdoor unit 16A through a refrigerant pipe, for example. The second air conditioner 12 is a multi-type air conditioner in which three indoor units 17B, 18B and 19B are connected to an outdoor unit 16B through a refrigerant pipe, for example. The third air conditioner 13 is a multi-type air conditioner in which three indoor units 17C, 18C and 19C are connected to an outdoor unit 16C through a refrigerant pipe, for example.

The first communication adaptor 21 is connected through an indoor/outdoor communication line 23 to the outdoor unit 16A and the indoor units 17A, 18A and 19A of the first air conditioner 11, and also connected to the outdoor unit 16B and the indoor units 17B, 18B and 19B of the second air conditioner 12. Accordingly, an air-conditioning control signal used for air-conditioning operation can be transmitted/received among the first communication adaptor 21, the outdoor unit 16A and the indoor units 17A, 18A and 19A of the first air conditioner 11 and the outdoor unit 16B and the indoor units 17B, 18B and 19B of the second air conditioner 12.

Furthermore, the second communication adaptor 22 is connected through an indoor/outdoor communication line 24 to the outdoor unit 16C and the indoor units 17C, 18C and 19C of the third air conditioner 13. Accordingly, an air-conditioning control signal used for air-conditioning operation can be transmitted/received among the second communication adaptor 22 and the outdoor unit 16C and the indoor units 17C, 18C and 19C of the third air conditioner 13.

The first communication adaptor 21 and the second communication adaptor 22 mutually convert the communication format of signals transmitted/received through a central control communication line 20, the indoor/outdoor communication line 23 and the indoor/outdoor communication line 24.

A remote controller (not shown) is connected to each of the indoor units 17A to 17C, 18A to 18C and 19A to 19C of the first air conditioner 11, the second air conditioner 12 and the third air conditioner 13 as occasion demands. When the remote controller is connected, operation/stop, change of setting temperature and switching of cooling, heating, etc. in the indoor units 17A to 17C, 18A to 18C and 19A to 19C are carried out by manual operation of the remote controller.

The central control device 15 is connected to the first communication adaptor 21 and the second communication adaptor 22 through the central control communication line 20. Accordingly, the central control device 15 is allowed to transmit/receive a central control signal through the first communication adaptor 21 to the first air conditioner 11 and the second air conditioner 12 and also through the second communication adaptor 22 to the third air conditioner 13.

The central control device 15 can obtain operation data, etc. based on the operation state of each of the indoor units 17A to 17C, 18A to 18C, 19A to 19C from the first air conditioner 11 and the second air conditioner 12 through the first communication adaptor 21 and also from the third air conditioner 13 through the second communication adaptor 22. Furthermore, the central control device 15 is equipped with a built-in HDD (built-in hard disk) 25 as a storage unit for storing various kinds of data, and an external HDD (external hard disk) 27 which serves as an auxiliary storage unit of the built-in HDD 25 and is connected to a connecting portion 26 of the central control device 15, and successively stores obtained operation data into a database stored in the built-in HDD 25. The operation data stored in the database of the built-in HDD 25 is converted in a CSV format, and transferred and stored into any indicated hard disk of the built-in HDD 25 and the external HDD 27. A generally-used externally-attached hard disk is used as the external HDD 27.

The central control device 15 concentrically controls the first air conditioner 11 and the second air conditioner 12 through the first communication adaptor 21, and also monitors the states of the first air conditioner 11 and the second air conditioner 12. Furthermore, the central control device 15 concentrically controls the third air conditioner 13 through the second communication adaptor 22 and also monitors the state of the third air conditioner 13.

In addition of the central control function and the state monitoring function of the first, second and third air conditioners 11, 12 and 13, the central control device 15 has the function of calculating the power proration rate (proportional distribution rate) as a consumed energy proration rate of each of the indoor units 17A to 17C, 18A to 18C and 19A to 19C of the first, second and third air conditioners 11, 12 and 13 and the consumed power amount as a consumed energy amount of each of the indoor units 17A to 17C, 18A to 18C and 19A to 19C based on the above power proration rate concerned.

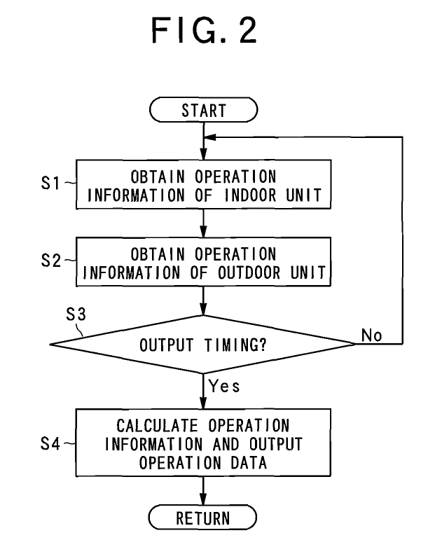

Next, the data obtaining processing and the output processing to the central control device 15 by the communication adaptor 21, 22 will be described with reference to the flowchart of FIG. 2.

The central control device 15 of this embodiment obtains the operation data, etc. in cooperation with the indoor units 17A to 17C, 18A to 18C and 19A to 19C, the outdoor units 16A to 16C and the first and second communication adaptors 21 and 22.

The communication adaptor 21, 22 first obtains operation information such as the wind speed of an air blowing fan (hereinafter referred to as wind speed), thermo ON/OFF, the temperatures at the inlet, the intermediate position and the outlet of a heat exchanger, the actual air blow speed of the fan, etc. from the respective indoor units 17A to 17C, 18A to 18C and 19A to 19C (step S1).

When obtaining the operation information of each of the indoor units 17A to 17C, 18A to 18C and 19A to 19C, the communication adaptor 21, 22 obtains operation information such as an operation power amount, a high-pressure saturation temperature, etc. from the respective outdoor units 16A to 16C (step S2).

When the operation information of each outdoor unit 16A to 16c is obtained, the communication adaptor 21, 22 judges whether an output timing for outputting the obtained operation information to the central control device 15 has come (step S3). Here, in this embodiment, this output timing is set to a time interval of 15 minutes, and thus the obtained operation information is output from the communication adaptor 21, 22 to the central control device 15 every 15 minutes. As a result, if it is judged that the output timing for outputting the obtained operation information has not yet come (step S3: NO), the communication adaptor 21, 22 repeats the series of processing from the step S1 until the output timing has elapsed.

As a result of the judgment of step S3, if it is judged that the output timing for outputting the obtained operation information has come (step S3: YES), the communication adaptor 21, 22 directly outputs the wind speed of the air blowing fan, the thermo ON/OFF, the operation power amount (or energy-saving operation power amount) out of the obtained operation information as operation data to the central control device 15. At this time, the communication adaptor 21, 22 calculates the degree of superheat and the degree of supercooling on the basis of the inlet temperature, the intermediate temperature, the outlet temperature and the high-pressure saturation temperature of the heat exchanger. Furthermore, the communication adaptor 21, 22 calculates a wind-speed reduced value on the basis of the actual wind speed of the fan. Still furthermore, the communication adaptor 21, 22 calculates the operation capacity rate on the basis of the calculated superheat degree and supercooling degree. Subsequently, the communication adaptor 21, 22 calculates the operation capacity amount of each of the indoor units 17A to 17C, 18A to 18C and the 19A to 19C on the basis of the wind-speed reduced value and the operation capacity rate of each of the indoor units 17A to 17C, 18A to 18C and 19A to 19C.

The communication adaptor 21, 22 counts power pulses from a power pulse meter in parallel to each processing described above, and outputs the count result to the central control device 15 (step S4).

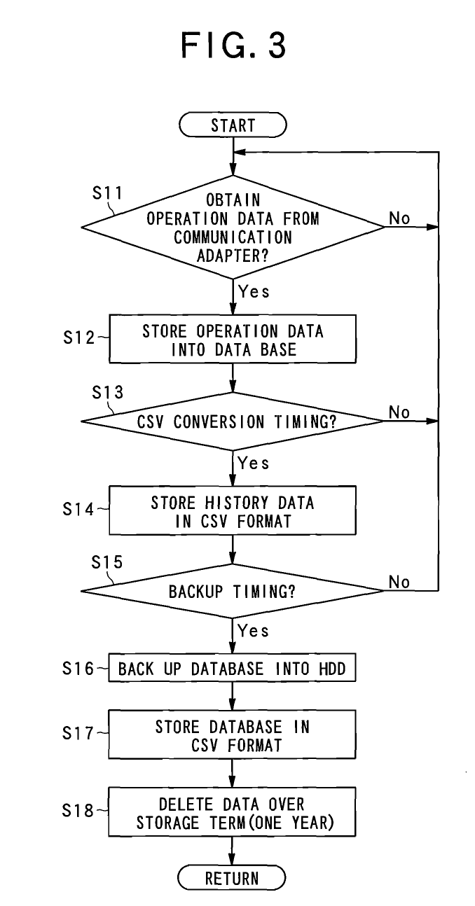

Next, the data obtaining processing of the central control device 15 will be described with reference to the flowchart of FIG. 3.

The central control device 15 first judges whether the operation data are obtained from the communication adaptor 21, 22 (step S11). As a result of this judgment, if it is judged that no operation data is obtained from the communication adaptor 21, 22 (step S11: NO), the processing of step S11 is repeated until some operation data is obtained.

On the other hand, as a result of the judgment of step S11, if it is judged that the operation data from the communication adaptor 21, 22 is obtained (step S11: YES), the central control device 15 stores the obtained operation data into the database of the built-in HDD 25 (step S12). Then, the central control device 15 judges whether the predetermined time corresponding to the format converting timing of the operation data to a CSV format has come (for example, twelve midnight at which the date is changed has come) (step S13).

As a result of the judgment, if the format converting timing of the operation data has not yet come (step S13: NO), the central control device 15 repeats the series of processing from the processing of the step S11.

On the other hand, as a result of the judgment of the step S13, if the format converting timing has come (step S13: YES), the central control device 15 generates history data of the CSV format from the operation data, and stores the generated history data into HDD 25 (step S14). At this time, the history data which are generated on a daily basis are grouped on a monthly basis and stored as a monthly-basis history data.

When the history data are stored in HDD 25, the central control device 15 judges whether a database backup timing has come (step S15). Here, the database backup timing is set on an annual basis in this embodiment.

As a result of this judgment, if the database backup timing has not yet come (step S15: NO), the central control device 15 repeats the series of processing from the processing of step S11.

As a result of the judgment of the step S15, if the database backup timing has come (step S15: YES), the central control device 15 stores the backup of the database into HDD 25 (step S16).

When the backup of the database is stored in HDD 25, the central control device 15 generates the database history data of the CSV format from the database, and stores the generated database history data into HDD 25 (step S17).

When the database history data is stored in HDD 25, the central control device 15 deletes data which have been stored for a predetermined storage period (for example, one year) or more (in detail, for 367 days or more in consideration of the leap year) from the database stored in the built-in HDD 25 (step S18). When the database stored in the storage unit are initialized, the central control device 15 returns to the processing of step S1.

Through the above processing, the central control device 15 successively stores the obtained operation data of the respective indoor units 17A to 17C, 18A to 18C, 19A to 19C into the database of the storage unit every 15 minutes. Furthermore, annually, the central control device 15 stores the backup of the database into HDD 25, generates the database history data of the CSV format from the operation data, stores the generated database history data into HDD 25 and then deletes the database stored in the storage unit.

Since the history data of the CSV format which are high in general versatility are stored in HDD 25, the central control device 15 can easily display the information based on the operation data such as the wind speed of the air blowing fan, the thermo ON/OFF, etc. of each of the indoor units 17A to 17C, 18A to 18C, 19A to 19C by using spreadsheet software or the like, perform edition such as re-calculation, etc. of the display result, search desired information, store the information into other media, etc. The history data which are obtained on a daily basis are grouped into monthly-basis history data and stored, and daily-basis history data of past one day are successively additionally stored in the monthly-basis history data corresponding to the present month every time one day has elapsed. Here, the monthly-basis history data are provided so that it is possible to refer to all the daily-basis history data stored in the history data of the present month when the history data of the present month are referred to on some day of the present month. The history data is based on the CSV format constructed by text data, and thus the data capacity thereof is smaller as compared with the operation data of the binary format, and thus the history data can be stored in HDD 25 for a long term.

Next, the calculation processing of charge prorating (proportional distribution rate) data by the central control device 15 will be described.

First, the central control device 15 extracts the wind speed of the air blowing fan, the thermo ON/OFF and the indoor rated capacity every indoor unit i (i=1 ton). Here, with respect to the indoor rated capacity, the rated capacity of each indoor unit i is stored and the rated capacity is output to the central control device 15 every time each indoor unit is started.

A thermo ON operation time of each indoor unit i for which each indoor unit i is operated under the thermo ON state is calculated as a thermo ON integrated operation time every wind mode of an intensive wind mode, a strong wind mode and a weak wind mode on the basis of the wind speed of the air blowing fan and the thermo ON/OFF by the central control device 15. Accordingly, the central control device 15 calculates an intensive-wind thermo ON integrated operation time SHHi, a strong-wind thermo ON integrated operation time SHi and a weak-wind thermo ON integrated operation time SHLi.

Furthermore, the central control device 15 calculates the rated capacity of each indoor unit i, that is, the capacity (kW(kilowatt) corresponding value) PSi from the indoor rated capacity.

Next, the central control device 15 calculates a convenient power consumption index TEi of each indoor unit i on the basis of the following equation.

TEi=(SHHi×αHH+SHi×αH+SLi×αL)×PSi

Here, αHH represents a wind-speed weighting coefficient of the intensive wind, αH represents a wind-speed weighting coefficient of the strong wind and αL represents a wind-speed weighting coefficient of the weak wind, and they are set in the range from 0.50 to 1.00 every wind speed in advance.

When the power consumption index TEi of each indoor unit i is calculated, the central control device 15 calculates the power consumption index TOTALe of all the indoor units (m units) of the air conditioning system as follows:

TOTALe=TE1+TE2+ . . . +Tem

Accordingly, the power consumption proration rate PEi (%(percentage)) of each indoor unit i is represented as follows:

REi(%)=(TEi/ToTALe)×100

When the group-basis power proration rate NEj (%) is calculated, the central control device 15 calculates the group-basis consumed power amount ME (kWh (kilowatt hour)) from the sum of pulse integration values Pe1, Pe2 obtained by multiplying the power pulses received from the communication adaptors 21, 22 to the calculated power proration rate NE. For example, the consumed power amount ME (kWh) of the group j is represented as follows, and the charge proration data is calculated.

MEj(kWh)=(Pe1+Pe2)×NEj

According to this embodiment, the central control device 15 successively the obtained operation data into the database of the storage unit, and when the charge proration data is required to be calculated, it calculates the charge proration data on the basis of the operation data extracted from the database. Accordingly, the daily processing of calculating the charge proration data on the basis of the obtained operation data of one day is unnecessary. Therefore, the operation data can be surely obtained, and data used to calculate the charge proration data can be prevented from being missing. Furthermore, even when the charge proration data is once calculated, the charge proration data can be calculated again.

Furthermore, according to this embodiment, the central control device 15 generates the history data and the database history data based on the CSV format on the basis of the operation data stored in the database of the storage unit. Accordingly, the history data can be generated in a general-purpose file format with which operation data generated in a non-general-purpose file format such as the wind-speed basis thermo ON integrated operation time, the wind-speed basis thermo OFF integrated operation time, etc. of each of the indoor units 17A to 17C, 18A to 18C, 19A to 19C usable by the central control device 15 are usable by an external general-purpose machine such as a personal computer or the like. Therefore, the information based on the operation data can be displayed by spreadsheet software, edition such as re-calculation, etc. can be performed on the display result, desired information can be searched and the information can be stored in other media.

At this time, the history data obtained on a daily basis are stored in the monthly-basis history data, and every time the central control device 15 obtains history data, the obtained history data are successively and additionally stored in the monthly-basis history data corresponding to the actual month. Therefore, when the actual day is some day of a month, monthly-basis history data which have been obtained until the actual day can be checked as the monthly-basis history data.

Furthermore, according to this embodiment, the backup of the database is stored in the built-in HDD having a high writing speed. Accordingly, the time for which the calculation processing capability of the central control device 15 is exclusively occupied by the processing of backing up the server, etc. can be shortened. Therefore, an adverse effect on other programs due to lack of the calculation processing capability of the central control device 15 or the like can be suppressed. Furthermore, the external HDD 27 which is different from the built-in HDD 25 of the central control device 15 in which operation data are successively stored is connected to the central control device 15, and the operation data can be transferred to the external HDD 27 every predetermined time. Therefore, the operation data can be also stored into the external HDD 27 with hardly affecting the processing of storing the operation data transmitted from the communication adaptors 21, 22.

### [2] Second Embodiment

The above first embodiment relates to the case where the energy being used is power in the air conditioning system. A second embodiment described below relates to a case where both gas and power are used as in the case of a gas heat pump (GHP) type air conditioner.

The construction of the air conditioning system is the same as the first embodiment, and the communication adaptors 21, 22 are provided so that a gas pulse from a gas pulse meter is output to the central control device 15. The processing of calculating the charge proration data by the central control device 15 when gas heat pump type air conditioners are contained in the air conditioning system 10 will be described hereunder.

First, the central control device 15 extracts the wind speed of the air blowing fan, the thermo ON/OFF and the indoor rated capacity from the database of the storage unit every indoor unit i (i=1 ton). Here, with respect to the indoor rated capacity, the rated capacity of each indoor unit i is stored, and the rated capacity is output to the central control device 15 every time each indoor unit is started.

The central control device 15 calculates a thermo OFF integrated operation time on a wind-speed basis of each indoor unit i as in the case of the wind-speed-basis thermo ON integrated operation time, and outputs the sum of the wind-speed-basis thermo ON integrated operation time and the wind-speed-basis thermo OFF integrated operation time, thereby calculating an intensive-wind integrated operation time RHHi, a strong-wind integrated operation time RHi and a weak-wind integrated operation time RLi of each indoor unit i.

Furthermore, the central control device 15 calculates the rated capacity of each indoor unit i, that is, the capacity (kW corresponding value) PSi from the indoor rated capacity.

Next, the central control device 15 calculates a convenient power consumption index TEi of each indoor unit i on the basis of the following equation.

TEi=(RHHi×αHH+RHi×αH+RLi×αL)×PSi

Here, αHH represents a wind-speed weighting coefficient of intensive wind, αH represents a wind-speed weighting coefficient of strong wind, and αL represents a wind-speed weighting coefficient of weak wind. For example, they are set in the range of 0.50 to 1.00 every wind speed in advance. When the power consumption index TEi of each indoor unit i and the outdoor energy consumption index TGi are calculated, the central control device 15 calculates the power consumption index TOTALe of all the indoor units (m units) of the air conditioning system on the basis of the total of the power consumption indexes TEi of the respective indoor units i, and also calculates the gas consumption index TOTAlg of all the indoor units (m units) of the air conditioning system as follows.

TOTALe=TE1+TE2+ . . . +TEm

TOTALg=TG1+TG2+ . . . +TGm

Accordingly, the power consumption proration rate REi (%(percentage)) of each indoor unit i is represented as follows:

REi(%)=(TEi/TOTALe)×100

Furthermore, the gas consumption proration rate RGi (%(percentage)) of each indoor unit i is represented as follows:

RGi(%)=(TGi/TOTALg)×100

When the indoor units i are grouped, the group-basis power proration rate NEj (%) and gas proration rate NGj (%) are calculated from the total of the power consumption proration rates REi and the total of the gas consumption proration rates of all the indoor units belonging to each group j.

When the group-basis power proration rate NEj is calculated, the central control device 15 calculates the group-basis consumed power amount MEj (kWh) from the sum of the pulse integrated values Pe1 and Pe2 obtained by multiplying the power pulses received from the communication adaptors 21, 22 to the calculated power proration rate NE. For example, the consumed power amount MEj of the group j is represented as follows.

MEj(kWh)=(Pe1+Pe2)×NEj

Furthermore, the pulse integrated value Pg calculated from the sum of the gas pulses received from the communication adaptors 21, 22 is multiplied by the calculated gas proration rate NGj, thereby calculating the group-basis consumed gas amount MGj (m³). For example, the consumed gas amount MGj of the group j is represented as follows.

MGj(m³)=Pg×NGj

### The charge proration data is calculated by the consumed power amount MEj and the consumed gas amount MGj.

According to this embodiment, the central control device 15 successively stores the obtained operation data into the database of the storage unit, and when the calculation of the charge proration data is required, the central control device 15 calculates the charge proration data on the basis of the operation data extracted from the database. Accordingly, the daily processing of calculating the charge proration data on the basis of the obtained operation data of one day is unnecessary. Therefore, the operation data can be surely obtained, and the data used to calculate the charge proration data can be prevented from being missing, and further even when the charge proration data is once calculated, the charge proration data can be calculated again.

Furthermore, according to this embodiment, the central control device 15 generates the history data and the database history data based on the CSV format on the basis of the operation data stored in the database of the storage unit. Accordingly, the history data can be generated in a general-purpose file format with which operation data generated in a non-general-purpose file format such as the wind-speed basis thermo ON integrated operation time, the wind-speed basis thermo OFF integrated operation time, etc. of each of the indoor units 17A to 17C, 18A to 18C, 19A to 19C usable by the central control device 15 are usable by an external general-purpose machine such as a personal computer or the like. Therefore, the information based on the operation data can be displayed by spreadsheet software, edition such as re-calculation, etc. can be performed on the display result, desired information can be searched and the information can be stored in other media.

At this time, the history data obtained on a daily basis are stored in the monthly-basis history data, and every time the central control device 15 obtains history data, the obtained history data are successively and additionally stored in the monthly-basis history data corresponding to the actual month. Therefore, when the actual day is some day of a month, monthly-basis history data which have been obtained until the actual day can be checked as the monthly-basis history data.

Furthermore, according to this embodiment, the backup of the database is stored in the built-in HDD having a high writing speed. Accordingly, the time for which the calculation processing capability of the central control device 15 is exclusively occupied by the processing of backing up the server, etc. can be shortened. Therefore, an adverse effect on other programs due to lack of the calculation processing capability of the central control device 15 or the like can be suppressed. Furthermore, the external HDD 27 which is different from the built-in HDD 25 of the central control device 15 in which operation data are successively stored is connected to the central control device 15, and the operation data can be transferred to the external HDD 27 every predetermined time. Therefore, the operation data can be also stored into the external HDD 27 with hardly affecting the processing of storing the operation data transmitted from the communication adaptors 21, 22.

The present invention is not limited to the above embodiments, and various modifications may be made without departing from the subject matter of the present invention.

For example, in the above embodiments, the backup and the generation of the history data are carried out every day. However, the present invention is not limited to this embodiments, and the time interval for the backup and the generation of the history data may be set freely.

Furthermore, in the above embodiments, the air conditioning system 10 is equipped with the two communication adaptors, 21, 22, the three outdoor units 16A to 16C and the nine indoor units 17A to 17C, 18A to 18C, 19A to 19C, however, the numbers of these elements may be set to any values.

Still furthermore, in the above embodiments, the history data are generated in the CSV format. However, the present invention is not limited to this embodiments. For example, the history data may be other text files than the CSV format insofar as they are expressed by delimiters and usable by an external general-purpose machine such as a personal computer or the like.

Still furthermore, in the above embodiments, every time the central control device 15 obtains operation data from the communication adaptors 21, 22, the central control device 15 stores the obtained operation data into the database. However, the present invention is not limited to these embodiments, and for example, the operation data may be obtained form the communication adaptors at all times, and the central control device may count the timing and store the operation data into the database periodically (for example, every 15 minutes) or store the operation data into the database at all times.

What is claimed is:

1. An air conditioning system containing at least one outdoor unit and plural indoor units and a central control device for concentrically controlling the overall air conditioning system and calculating an energy using charge corresponding to an energy using amount of each indoor unit as a charge proration data, wherein the central control device comprising:
an operation data obtaining unit for obtaining an operation data based on an operation state of each indoor unit every predetermined time;
a storing unit for successively storing the obtained operation data in a database; and
a calculation unit for extracting the operation data used to calculate the charge proration data from the database and calculating the charge proration data on the basis of the extracted operation data.

2. The air conditioning system according to claim 1, wherein the database is created in a unique file format usable by the central control device, and the central control device creates history data in a general-purpose file format usable by external equipment on the basis of the operation data stored in the database.

3. The air conditioning system according to claim 2, wherein the history data are grouped on a monthly basis, daily-basis history data of past one day are successively added to the history data of a present month every time one day elapses, and all daily-basis history data stored in the history data of the present month can be referred to when the history data of the present month are referred to on some day of the present month.

4. The air conditioning system according to claim 1, wherein the central control device has a hard disk for backing up the operation data stored in the data base.

5. A method of controlling an air conditioning system containing at least one outdoor unit and plural indoor units and controlling the overall air conditioning system and calculating an energy using charge corresponding to an energy using amount of each indoor unit as a charge proration data, comprising:
an operation data obtaining step for obtaining an operation data based on an operation state of each indoor unit every predetermined time;
a storing step for successively storing the obtained operation data in a database; and
a calculation step for extracting the operation data used to calculate the charge proration data from the database and calculating the charge proration data on the basis of the extracted operation data.
